(19) United States
(12) Patent Application Publication
(10) Pub. No.: US 2003/0072953 A1
(43) Pub. Date: Apr. 17, 2003

(54) Aceto acetonate and related compounds as adhesion promoters

(76) Inventors: Osama M. Musa, Hillsborough, NJ (US); Harry Richard Kuder, Fullerton, CA (US)

Correspondence Address: Jane E. Gennaro, Assistant General Counsel I.P., NATIONAL STARCH AND CHEMICAL COMPANY, 10 Finderne Avenue, Bridgewater, NJ, 08807-0500, US

(21) Appl. No.: 09/966,135

(22) Filed: Sep. 28, 2001

(51) Int. Cl. B32B 15/08

(52) U.S. Cl. 428/457; 428/626

(57) ABSTRACT

Curable compositions containing aceto acetonate compounds or related compounds can be used to promote adhesion to metal substrates, either by coating on the metal substrate or by addition to the adhesive formulation.

### FIELD OF THE INVENTION

This invention relates to curable compositions containing aceto acetonate compounds and related compounds as adhesion promoters.

### BACKGROUND OF THE INVENTION

In the fabrication and assembly of semiconductor packages, an integrated circuit chip or die is attached to a lead frame with adhesive and wire bonding and the die and inner lead frame assembly encapsulated in a molding resin. After encapsulation, the outer leads of the lead frame are attached to a printed circuit board or other external device. Any exposed copper surfaces on lead frames or printed wire boards are subject to oxidation with exposure to air and are routinely coated with antioxidants. However, the presence of these compounds is suspected of interfering with the bonding process during the die attach, wire bonding, encapsulation, and final soldering operations in the manufacture of the semiconductor package and its attachment to a printed circuit board. Therefore, it would be advantageous to find a material that is able to retard oxidation of metal substrates and improve adhesion.

### SUMMARY OF THE INVENTION

This invention is a curable composition that can be used to coat metal substrates, and in particular metal leadframes, or that can be used in adhesive or encapsulation compositions, in the fabrication of semiconductor devices. The curable composition will comprise a compound having at least one aceto acetonate, aceto acetamide, or aceto acethioate functionality and at least one polymerizable functionality. The polymerizable functionality preferably will be an electron donor, electron acceptor, or epoxy.

The function of the aceto acetonate or related functionality is to act as an adhesion promoter to metal surfaces. The function of the polymerizable functionality is to immobilize the aceto acetonate or related segment and prevent it from interfering with manufacturing operations that are conducted proximate to metal surfaces.

These compounds may be coated on exposed metal surfaces, such as the copper or silver surfaces of a semiconductor device or printed circuit board, or may be added to adhesive, coating, encapsulant, or other curable compositions that come into contact with or are required to bond to metal surfaces.

### DETAILED DESCRIPTION OF THE INVENTION

In its broadest embodiment the curable composition will comprise a compound having at least one aceto acetonate, aceto acetamide, or aceto acethioate functionality and at least one polymerizable functionality. In another embodiment, the compound having at least one aceto acetonate, aceto acetamide, or aceto acethioate functionality and at least one polymerizable functionality will have the structure:

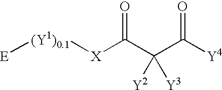

in which X is O, alkyl, NY¹, or S; Y¹, Y², Y³, and Y⁴ are the same or a different hydrocarbyl; and E is an electron donor, electron acceptor, or epoxy functionality.

Within this specification and claims hydrocarbyl group means an organic moiety containing hydrogen and carbon, and optionally heteroatoms such as oxygen, nitrogen or sulfur. For example, hydrocarbyl includes linear or branched alkyl or alkenyl groups or cyclic alkyl or alkenyl groups, or aromatic groups.

Exemplary electron donor groups are vinyl ethers, vinyl silanes, compounds containing carbon to carbon double bonds attached to an aromatic ring and conjugated with the unsaturation in the aromatic ring, such as compounds derived from cinnamyl and styrenic starting compounds. Exemplary electron acceptor groups are acrylates, fumarates, maleates, and maleimides.

When used as an additive in a formulation, the compounds will be added neat and in an effective amount to promote adhesion. In general, an effective amount will range from 0.005 to 20.0 percent by weight of the adhesive, coating, or encapsulant formulation. In addition, such formulations will contain a predominant curable resin, and optionally a curing initiator, and optionally a conductive or nonconductive filler.

Suitable curable resins that may be used as the predominant resin in the formulation include epoxies, vinyl ethers, vinyl silanes, thiol-enes, compounds derived from cinnamyl and styrenic starting compounds, fumarates, maleates, acrylates, and maleimides.

Suitable curing agents are thermal initiators and photoinitiators present in an effective amount to cure the curable composition. In general, those amounts will range from 0.5% to 30%, preferably 1% to 20%, by weight of the total organic material (that is, excluding any inorganic fillers) in the formulation. Preferred thermal initiators include peroxides, such as butyl peroctoates and dicumyl peroxide, and azo compounds, such as 2,2′-azobis(2-methyl-propanenitrile) and 2,2′-azobis(2-methyl-butanenitrile). A preferred series of photoinitiators is one sold under the trademark Irgacure by Ciba Specialty Chemicals. In some formulations, both thermal initiation and photoinitiation may be desirable: the curing process can be started either by irradiation, followed by heat, or can be started by heat, followed by irradiation.

In general, the formulations will cure within a temperature range of 70° C. to 250° C., and curing will be effected within a range of ten seconds to three hours. The actual cure profile will vary with the components and can be determined without undue experimentation by the practitioner.

The formulations may also comprise electrically or thermally conductive fillers or nonconductive fillers. Exemplary conductive fillers are carbon black, graphite, gold, silver, copper, platinum, palladium, nickel, aluminum, silicon carbide, boron nitride, diamond, and alumina. Exemplary nonconductive fillers are particles of vermiculite, mica, wollastonite, calcium carbonate, titania, sand, glass, fused silica, fumed silica, barium sulfate, and halogenated ethylene polymers, such as tetrafluoroethylene, trifluoroethylene, vinylidene fluoride, vinyl fluoride, vinylidene chloride, and vinyl chloride. If present, fillers generally will be in amounts of 20% to 90% by weight of the formulation.

In another embodiment, the aceto acetonate and related compounds of this invention can be used to coat exposed metal surfaces. (The metal surface may first be degreased, cleaned, polished or buffed.) In this embodiment, the aceto acetonate and related compounds typically are used at a concentration of 0.5% to 20% in any suitable solvent. Representative suitable solvents are water, ketones (such as, methyl ethyl ketone, methyl isobutyl ketone, acetone), alcohols, glycol ethers, esters, and toluene.

The metal substrate is immersed in the solution for a period of time sufficient to deposit an effective coating. Immersion times typically will range from one second to one hour, more typically one minute to 15 minutes, although shorter or longer times may be effective depending on the particular aceto acetonate or related compound, solution strength, and solution temperature. In general, the solution bath will be at a temperature within the range of 15° C. to 100° C. Alternatively, the aceto acetonate and related compounds in solution can be sprayed or painted onto the metal surface to be coated. The solution is typically air-dried from the surface, and then cured at an elevated temperature suitable for removing any remaining solvent and for effecting curing.

### EXAMPLES

### Example 1

Performance of aceto acetonate as coating on copper and silver surfaces. Copper and silver leadframes were dipped into a solution of an aceto acetonate compound, at a concentration of 1% -2% by weight in methanol, were air-dried and then cured for 30 minutes at 120° C. Two aceto acetonate compounds were used as the coating compound.

Compound A had the Structure:

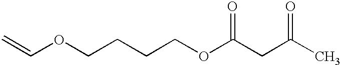

Compound B had the Structure:

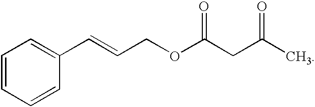

The leadframes were then used as the substrate for a silicon die, 500×500 mil. An adhesive formulation was prepared comprising a bismaleimide, a compound with cinnamyl functionality, an epoxy, curing agents, and 75% by weight silver. The adhesive was dispensed on the leadframe, the silicon die placed onto the adhesive, and the adhesive cured in an oven at 175° C. for 30 minutes. The cured assemblies were then subjected to 85° C./85% relative humidity for 48 hours, after which the die was sheared from the leadframe at 90 degrees with a Dage 2400-PC Die Shear Tester at 260° C.

Ten assemblies for each coating composition per leadframe were tested and the average given in Kilogram force as the result. The results are set out in the following table and show that the use of an aceto acetonate compound as a coating composition for metal leadframes improves the adhesion of the adhesive composition to the leadframe compared to the adhesion without the coating.

| | Die Shear Strength at 260° C. |
|---|---|
| Aceto Acetonate Coating | in KgF |
| None on copper leadframe | 11.4 |
| Compound A on copper | 42.4 |
| leadframe | |
| Compound B on copper | 37.9 |
| leadframe | |
| None on silver leadframe | 20.1 |
| Compound A on silver | 24.5 |
| leadframe | |
| Compound B on silver | 30.0 |
| leadframe | |

### Example 2

Performance of aceto acetonate as an additive to curable compositions for use on metal substrates. A control adhesive formulation was prepared comprising a bismaleimide, a compound with styrenic functionality, a radical initiator, a standard siloxane adhesion promoter (a blend of Silquest A-174 and A-186 from Witco Corp.) and 75% by weight silver. To this formulation was added 0.07% by weight of either Compound A or Compound B from Example 1. The adhesive was dispensed on a silver or copper coated leadframe, a silicon die was placed onto the adhesive, and the adhesive cured on a hot plate at 200° C. for 60 seconds. After cure the die was sheared from the leadframe at 90 degrees with a Dage 2400-PC Die Shear Tester at 240° C.

Ten assemblies for each composition per leadframe were tested for die shear strength given in KgF, and the results pooled and averaged. The results are set out in the following table and show that the addition of an aceto acetonate compound to die attach compositions significantly improves the adhesion of the composition to silver leadframes, and gives similar results in adhesion to copper leadframes, compared to compositions containing standard siloxane adhesion promoters.

| | Die Shear Strength at 240° C. |
|---|---|
| COMPOSITION | in KgF |
| Control on Cu leadframe | 1.2 |
| Control with compound A | 1.5 |
| on Cu leadframe | |
| Control with compound B | 1.6 |
| on Cu leadframe | |
| Control on Ag leadframe | 0.75 |
| Control with compound A | 1.5 |
| on Ag leadframe | |
| Control with compound B | 1.2 |
| on Ag leadframe | |

What is claimed:

1. A curable die attach composition with improved adhesion to metal substrates comprising a compound having the structure: 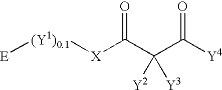
in which X is O, alkyl, NY¹, or S; Y¹, Y², Y³, and Y⁴ are the same or a different hydrocarbyl; and E is an electron donor, electron acceptor, or epoxy functionality.

2. The curable composition according to claim 1 in which the curable composition comprises a compound having the structure:

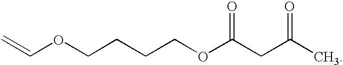

3. The curable composition according to claim 1 in which the curable composition comprises a compound having the structure:

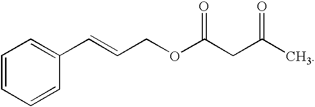

4. A metal substrate coated with a curable composition comprising a compound having the structure 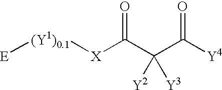
in which X is O, alkyl, NY¹, or S; Y¹, Y², Y³, and Y⁴ are the same or a different hydrocarbyl; and E is an electron donor, electron acceptor, or epoxy functionality.

5. The metal substrate according to claim 4 in which the metal substrate is a copper or silver coated leadframe.

6. The metal substrate according to claim 4 coated with a curable composition comprising a compound having the structure

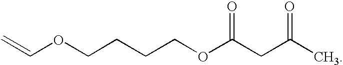

7. The metal substrate according to claim 4 coated with a curable composition comprising a compound having the structure [chemical structure]
